(19) United States
(12) Patent Application Publication
(10) Pub. No.: US 2025/0284377 A1
(43) Pub. Date: Sep. 11, 2025

(54) SERVICE PROVIDING APPARATUS PROVIDING CHARACTER CUSTOMIZATION AND OPERATION METHOD OF THE SERVICE PROVIDING APPARATUS

(71) Applicant: Nexon Korea Corporation, Seongnam-si (KR)

(72) Inventors: Jung Kyu YE, Seongnam-si (KR); Sung Ho MOON, Seongnam-si (KR); Yu Jun KIM, Seongnam-si (KR); Na Eun LEE, Seongnam-si (KR)

(21) Appl. No.: 19/066,042

(22) Filed: Feb. 27, 2025

(30) Foreign Application Priority Data
Mar. 7, 2024 (KR) 10-2024-0032695
Jul. 9, 2024 (KR) 10-2024-0090397

(51) Int. Cl. G06F 3/0482

(52) U.S. Cl. CPC G06F 3/0482

(57) ABSTRACT

A service providing apparatus providing character customization, and an operation method of the service providing apparatus are proposed. The method includes (a) receiving selection information from a user regarding a category that includes items to be used for coordinating the character, (b) displaying a plurality of items within the category selected in the step (a) and the character on a screen; (c) receiving a selection of one item among the plurality of items displayed on the screen from the user, and (d) changing the coordination of the character with the one item selected in the step (c).

### BACKGROUND

### Technical Field

Embodiments disclosed in this specification relate to a service providing apparatus providing character customization, and an operation method of the service providing apparatus.

### Description of the Related Art

Character Customization is a feature that allows users to freely change the appearance, clothing, etc. of characters, and enhances personal connection with the characters and strengthens self-expression within SNS (Social Network Service), games, or other applications. One method for character customization can be exemplified by direct adjustment through a user interface.

As the most basic form of customization, users can change the appearance of their characters by selecting from a few predefined options. This customization allows the character's clothing, hairstyle, skin color, and more to be changed to match the user's preferences.

In general, character customization provides coordination items arranged in multiple rows and columns such that users select one coordination item from the items arranged in multiple rows and columns. However, when providing items arranged in multiple rows and columns, the number of items that users can see at once is small, so it is difficult to present a large variety of coordination items to users.

### SUMMARY

Embodiments disclosed in the specification are embodiments for solving the problems described above and an objective of the present disclosure is to provide a service providing apparatus providing character customization that can propose various coordination items to users in a user-friendly way, and an operation method of the service providing apparatus.

Another objective of the present disclosure is to provide a service providing apparatus providing character customization that enables more convenient change of items, and an operation method of the service providing apparatus.

A method of providing character customization according to an embodiment includes: (a) receiving selection information from a user regarding a category that includes items to be used for coordinating the character; (b) displaying a plurality of items within the category selected in the step (a) and the character on a screen; (c) receiving a selection of one item among the plurality of items displayed on the screen from the user; and (d) changing the coordination of the character with the one item selected in the step (c).

In detail, in the step (c), the selection of the one item among the plurality of items by the user may be performed by one of the following: pressing the one item; or contact between the one item and an area of the character caused by a movement of the one item among the plurality of items.

Additionally, the movement of the one item among the plurality of items may be performed by moving a display area itself of the plurality of items on the screen.

In the step (b), the plurality of items each may be displayed in different sizes, depending on a distance from the character.

According to the service providing apparatus providing character customization of an embodiment disclosed in the specification and an operation method of the service providing apparatus, it is possible to propose various coordination items to users in a user-friendly way, and it is also possible to more conveniently change items.

### BRIEF DESCRIPTION OF THE DRAWINGS

FIG. 1 is a configuration diagram of a service providing apparatus providing character customization according to an embodiment;

FIG. 2 is an exemplary diagram showing item classification according to an embodiment;

FIG. 3 is an exemplary diagram in which various items corresponding to a hair category are displayed together when an icon representing the category corresponding to hair in a subclassification is selected;

FIG. 4A and FIG. 4B are diagrams illustrating methods of arranging and moving a plurality of items according to embodiments, respectively;

FIG. 5A and FIG. 5B are diagrams illustrating a method of moving and bringing one item of the plurality of items into contact with a character in accordance with an embodiment;

FIG. 6 is a diagram illustrating a method of presenting an item when changing the coordination of a character by moving one item of the plurality of items in accordance with an embodiment;

FIG. 7A and FIG. 7B are exemplary diagrams showing category icons on the screen of a user terminal according to embodiments;

FIG. 8 is a diagram illustrating a method of removing an item;

FIG. 9A and FIG. 9B are diagrams illustrating a method of arranging the plurality of items on a screen; and

FIG. 10 is a flowchart of a method of providing character customization according to an embodiment.

### DETAILED DESCRIPTION

Hereafter, a service providing apparatus providing character customization according to embodiments of the present disclosure and an operation method of the service providing apparatus are described in detail with reference to the accompanying drawings. The following embodiments of the present disclosure are provided only to exemplify the present disclosure and are not intended to limit or restrict the scope of the present disclosure. Matters that can be readily inferred by those skilled in the art from the detailed description and embodiments of the present disclosure should be construed as falling within the scope of the present disclosure.

The term “character” used in this specification refers to a virtual figure or agent designed to humanize or add an emotional aspect to interactions between a user and an application program. The “character” may also be referred to as an “avatar” in other terms.

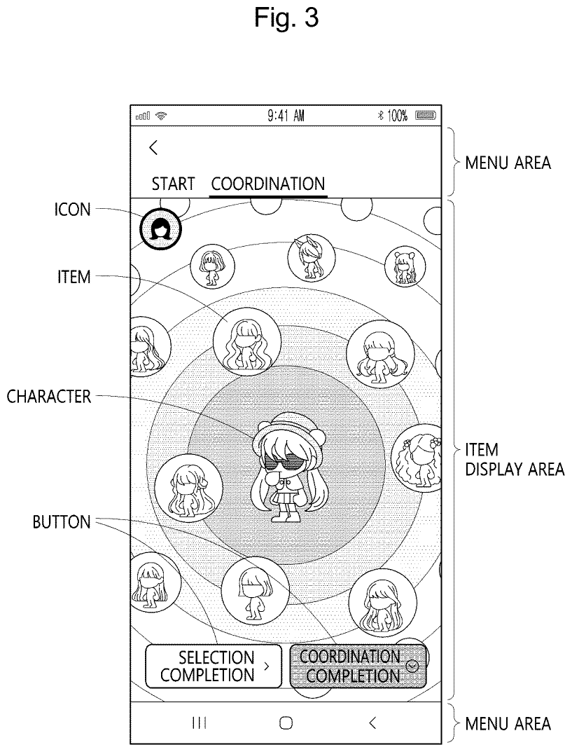

For reference, items are not shown in some circles in FIGS. 3, 5B, 7A, and 7B of the accompanying drawings, but, actually, items are displayed.

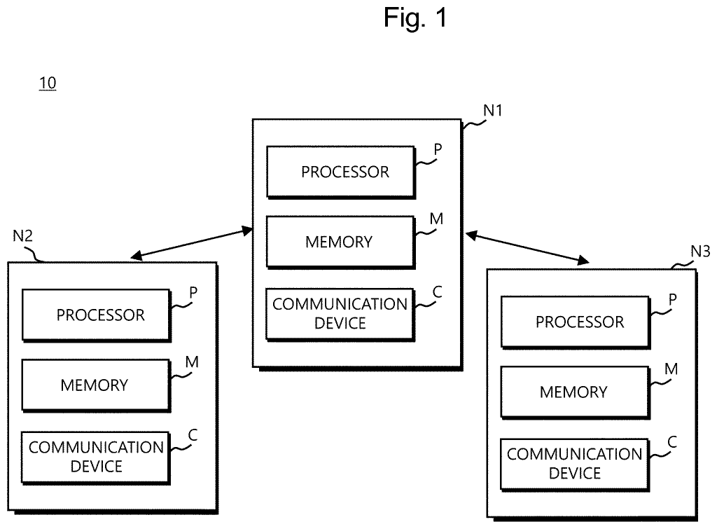

FIG. 1 is a configuration diagram of a service providing apparatus 10 providing character customization according to an embodiment.

The service providing apparatus 10 providing character customization according to an embodiment of the present disclosure may be a service providing server, a user terminal, a game system including a service providing server and a user terminal, or an independent single apparatus. That is, the service providing apparatus 10 may be implemented as a terminal, may be implemented as a server, and may be implemented as a structure in which a terminal and a server are integrated.

For example, the service providing apparatus 10 is provided as multiple nodes N1, N2, and N3 in FIG. 1, but the service providing apparatus 10 may include at least one N1, N2, N3 of the multiple nodes N1, N2, and N3, and the nodes N1, N2, and N3 each may be one of a service providing server or a user terminal.

Further, the nodes N1, N2, and N3 each may include at least one processor P, at least one memory M, and at least one communication device C. Instructions that can be executed by the at least one processor P are included in at least one memory M and the at least one processor P executes the instructions. The at least one communication device C is a device for communication of a corresponding node N1, N2, and N3 with external devices.

At least some of the nodes N1, N2, and N3 may have various input devices including a keyboard receiving data and various output devices such as a display for displaying data, etc. on a screen.

The service providing apparatus 10 can classify various items, which can coordinate characters, into multiple levels of categories.

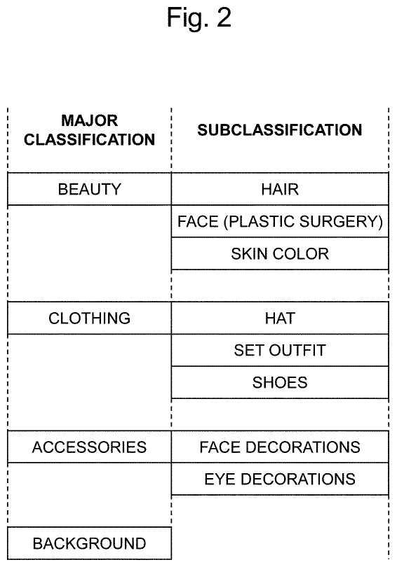

FIG. 2 is an exemplary diagram showing item classification according to an embodiment.

As can be seen from FIG. 2, beauty, clothing, accessories, and background are set as categories of a major classification, and categories of hair, face (plastic surgery), skin color, hat, full-body outfit, shoes, face decorations, and eye decorations (glasses) may be included in a subclassification under the major classification.

When a user clicks an icon indicting a category of the major classification on a screen of the user, the icons of the categories of the subclassification that correspond to the category of the major classification expand and are displayed on the user's screen.

FIG. 3 is an exemplary diagram in which various items corresponding to a hair category are displayed together when an icon representing the category corresponding to hair in a subclassification is selected. Not only an item display area, but a menu area are shown in FIG. 3, but only an item display area is shown in the figures other than FIG. 3.

As can be seen from FIG. 3, a character, the icons of the currently selected category, a plurality of items, a selection completion button showing completion of selection, and a coordination completion button showing completion of coordination may be displayed on the user's screen by the service providing apparatus 10.

Each category can be represented by an icon. When the subclassification is selected by the user, the service providing apparatus 10 represents the main icon displayed on the screen as a subclassification icon.

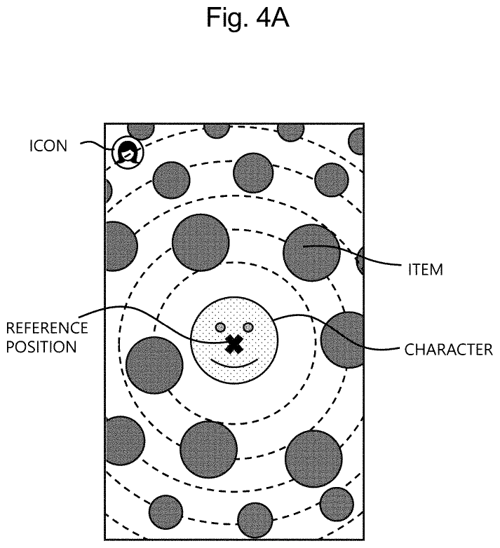

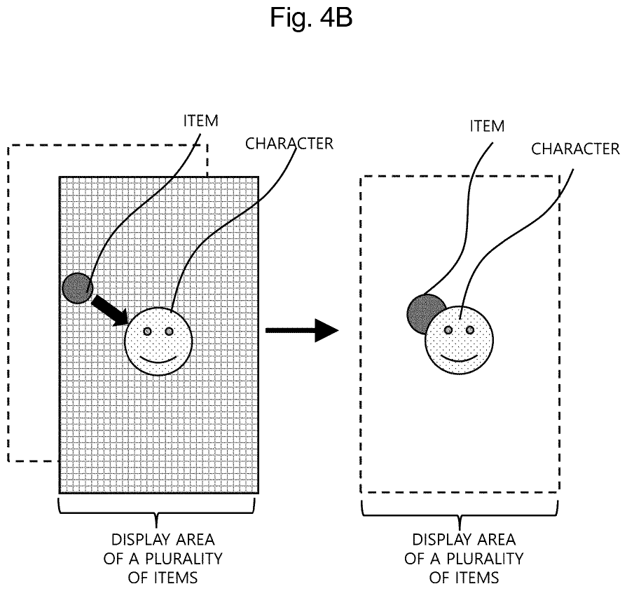

FIG. 4A and FIG. 4B are diagrams illustrating methods of arranging and moving the plurality of items according to embodiments, respectively. Multiple circles indicated by dotted lines in FIG. 4A are shown as a reference so that the distances from a reference position can be easily identified.

The service providing apparatus 10 can receive selection information of a category including items to be used for coordinating the character from the user and can display the items of the selected category and the character on the screen of the user. The selected category is represented by an icon on the user's screen.

The character is fixedly disposed at a predetermined reference position on the screen. That is, the reference position may be set as a character position. In detail, the reference position may be set as the center position of the character. For reference, the character may be arranged at the center of the display area of the plurality of items or at a position slightly deviated from the center.

The plurality of items may be displayed in different sizes, depending on the distances from the reference position on the screen. Specifically, the item closest to the reference position may be displayed the largest, and the item farthest from the reference position may be displayed the smallest.

In detail, a method of displaying items in different sizes, depending on the distances from the reference position on the screen can be implemented in various ways as follows.

An item can be displayed larger as it gets closer to the reference position and smaller as it moves away from the reference position.

An item display area can be divided into multiple sections in accordance with the distance from the reference position, items can be displayed in different sizes in the sections, and items can be displayed larger in sections closer to the reference positions.

An item can be displayed larger as it gets closer to the reference position and smaller as it moves away from the reference position, and items within a predetermined distance from the reference position can be displayed in the same size. For reference, items are displayed in FIG. 3 to FIG. 8 in accordance with this method.

For example, the distance between an item and the reference position may be the distance between the center of the item and the reference position or the distance between the point of the item closest to the reference position and the reference position.

As described above, by arranging items, which the user is highly interested in, closer to the character, it is possible to increase the focus of the user on closer items, that is, items closer to the reference position. Further, it is possible to display a large number of items at once on a single screen by arranging the plurality of items in different sizes.

Meanwhile, the plurality of items may be arranged on direction and moved toward an item selected by the user, and items that the user is highly interested in may be displayed as large icons. When the display area of the plurality of items is moved by a swipe or mouse action, the size of each of the plurality of items is adjusted on the basis of the distance from a reference position. When the display area of the plurality of items is moved, the distance of each of the plurality of items from the reference position can also be adjusted. That is, items closer to the reference position can be moved more as the display area of the plurality of items is moved.

By the method described above, the user can simultaneously check the plurality of items on one screen and can easily find items of his/her desired preference. Therefore, according to the service providing apparatus 10 providing character customization of the present disclosure, the user's convenience in selecting items can be greatly improved.

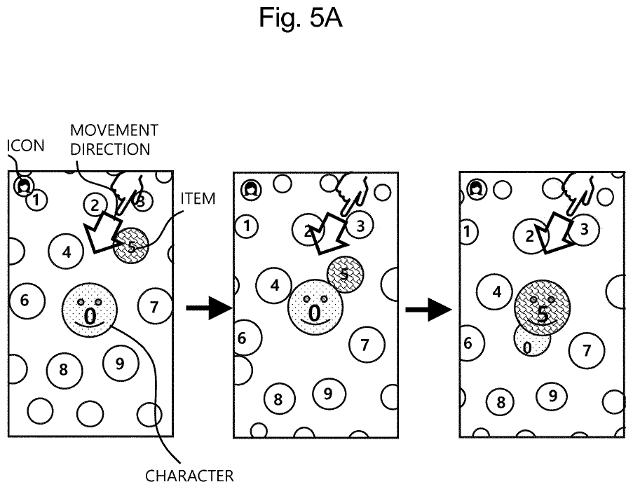

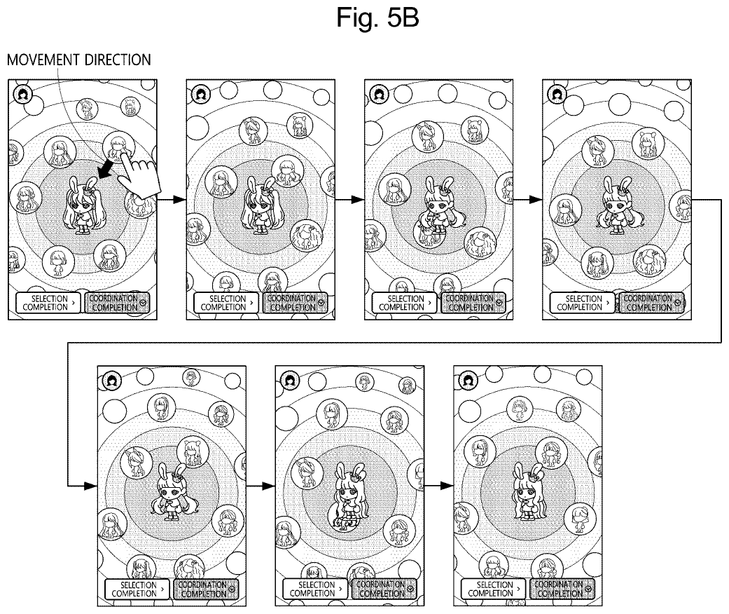

FIG. 5A and FIG. 5B are diagrams illustrating a method of changing the coordination of the character by moving one item of multiple items in accordance with an embodiment.

It is exemplified in FIG. 5A that the coordination item of the character is changed from item ‘0’ to item ‘5’. It can be seen that, in FIG. 5B, the coordination of the character has been changed twice by moving the display area of the plurality of items. For reference, FIG. 5A corresponds to the upper left three images in FIG. 5B.

The service providing apparatus 10 can receive a selection of one item among the plurality of items by the user and can change the coordination of the character with the selected item.

The selection of the one item among the plurality of items by the user may be performed by one of the following: pressing the one item; or contact between the one item and the character's area caused by a movement of the one item among the plurality of items.

That is, when an item is pressed by tapping or clicking the item, the item can be worn immediately, and an item can be worn by bringing the item into contact with the area of a character. Contact with the area of the character may be exemplified by the overlapping of the area of an item and the area of the character over a preset area. The area of the character is set as a shape centered around the reference position and the character is arranged in the area of the character. The shape centered around the reference position may be exemplified by a circle within a predetermined distance from the reference position.

That is, when the area of the character for coordination are displayed on one screen and the screen itself is moved to make contact with the area of the character, the item is worn. Beyond the limitation of list-based user interfaces (UI) providing a small number of products that the user can see at once, according to the service providing apparatus 10 providing character customization of the present disclosure, it is possible to provide a large number of items and display the plurality of items at once so that the user can conveniently select items of his/her desired preference.

When one item is brought into contact with the character by moving the display area itself of the plurality of items displayed on the screen through a swipe or mouse action, the coordination of the character is changed with the item and the user can finally change and replace the coordination of the character by pressing the button indicating completion of selection for coordination of the character. That is, when the button is pressed, the coordination information of the character based on the item is stored in the service providing apparatus 10.

When the coordination of the character is changed with the item, the previously worn item is moved in the movement direction of the display area of the plurality of items on the screen. In detail, when one item is brought into contact with the character by moving the display area of the plurality of items in a first direction, the previously worn item is moved from the character in the first direction. That is, the item worn on the character before the coordination of the character is changed is moved from the character in the opposite direction of a first location. In this case, the first position is the position of the item, which is worn on the character to change the coordination of the character, before being worn on the character. In summary, a second item is moved to a position that is symmetrically opposite to a first location relative to the character's position on the screen. The first position is the position of a first item before the first item is worn on the character. The first item is an item worn on the character after the change in the character's coordination and the second item is an item worn on the character before the change in the character's coordination.

For reference, when one item is selected among the plurality of items by pressing the item and the coordination of the character is changed with the selected one item, the item worn on the character before the coordination of the character is changed is moved in the opposite direction of the first position. Similarly, the first position is the position of the item, which is worn on the character to change the coordination of the character, before being worn on the character. That is, when the first item is worn on the character and the coordination is changed, the second item, which is the previously worn item, is moved in the opposite direction from the character by a distance corresponding to a first distance that is the distance between the first item and the character before the coordination is changed. In this case, the display area of the plurality of items is also moved by the same distance in the same direction as the second item.

Alternatively, when the coordination of the character is changed with a selected item, the previously worn item may be moved to the initial position of the selected item or to the position before the item currently worn on the character is moved.

According to the method described above, the user can quickly try multiple items on the character and can easily compare the appearances of the character wearing different items.

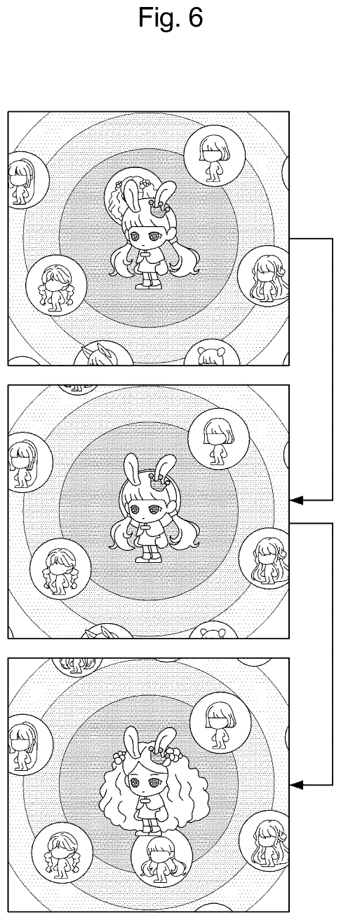

FIG. 6 is a diagram illustrating a method of presenting an item when changing the coordination of the character by moving one item of the plurality of items in accordance with an embodiment.

As can be seen from FIG. 6, the service providing apparatus 10 can render a screen where the item to be worn by the character is drawn toward the character. The effect where the item is drawn toward the character may be exemplified by an effect resembling the item being magnetically attracted to a character when worn. Further, the service providing apparatus 10 may render a screen where a previously worn item is ejected from the character after a new item is drawn toward the character. Accordingly, the previously worn item is made to come out, whereby it is possible to quickly try on items in comparison to the existing methods, which makes comparison easier.

Specifically, when the character's area comes in contact with an item, the item is automatically moved to the center of a rear side of the character's area and then the coordination of the character is changed with the item. Further, the item worn on the character before the coordination is changed is automatically ejected out of the character's area through the rear side of the character's area.

That is, a movement of the one item among the plurality of items can be performed by moving the display area itself of the plurality of items. Accordingly, not only the item, but the display area itself of the plurality of items displayed on the screen is shifted. Since the display area itself of the plurality of items displayed on the screen is moved, items that the user is highly interested in can be moved closer to the character.

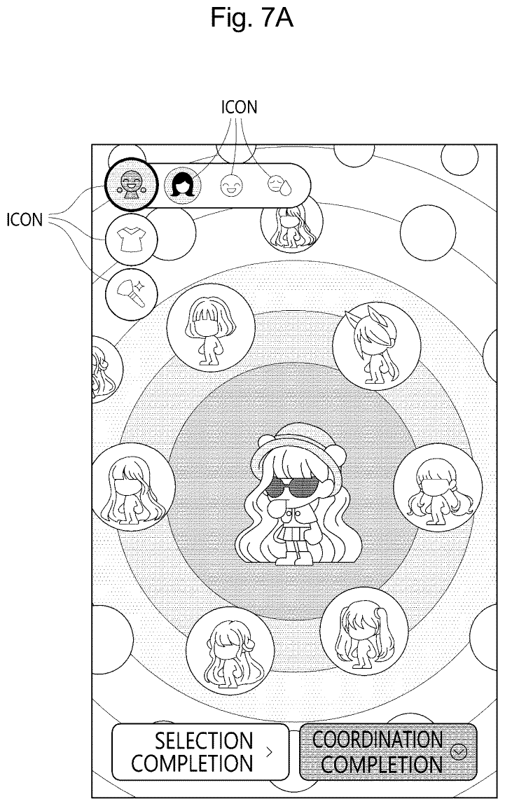

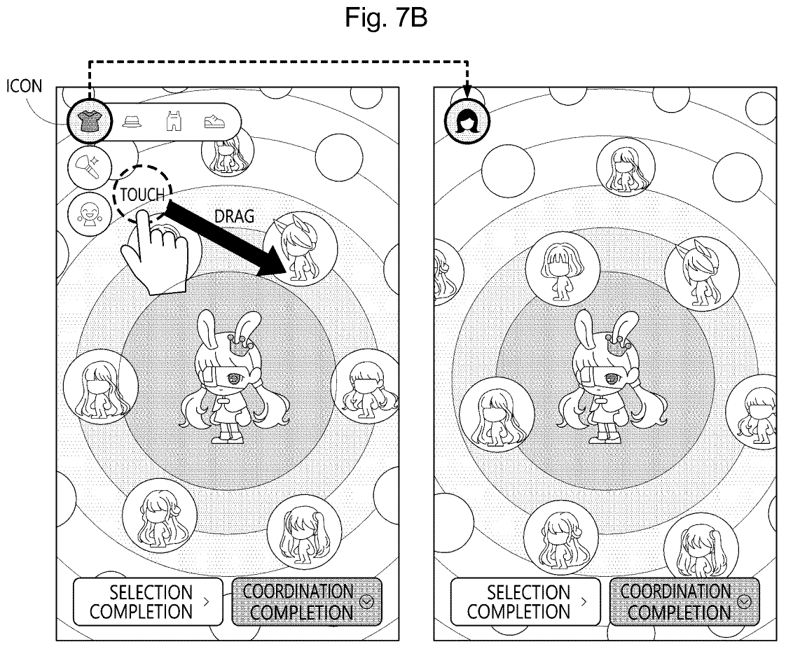

FIG. 7A and FIG. 7B are exemplary diagrams showing category icons on the screen of the user according to embodiments.

When the user expands a menu by pressing a category icon, the service providing apparatus 10 displays the main icon into the icons of the major classification on the user's screen. When the user moves the background screen list (desktop list) while exploring other categories, it is possible to change to the current category. The background screen list can be moved by touch and drag.

That is, by moving the background screen through touch and drag with an icon representing other category items activated on the screen, the icon representing the current category items can be changed into an activated state.

A removal function may be added for facial decoration or glasses that are not essential options. That is, when there is no item removal function, there is an issue where facial decoration and glasses must always be worn.

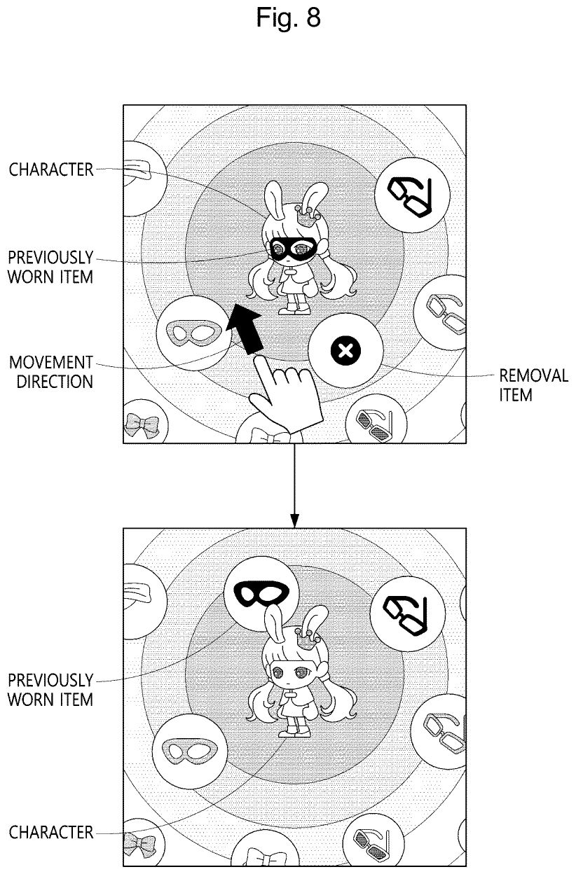

FIG. 8 is a diagram illustrating a method of removing an item.

When a removal item is selected among the plurality of items displayed on the screen, the item currently worn on the character can be removed.

That is, at least one category of the categories containing items used to coordinate the character may include an item that can remove the item of the at least one category currently worn on the character. Accordingly, the item of the category is not worn on the character and the previously worn item is moved in the movement direction of the screen.

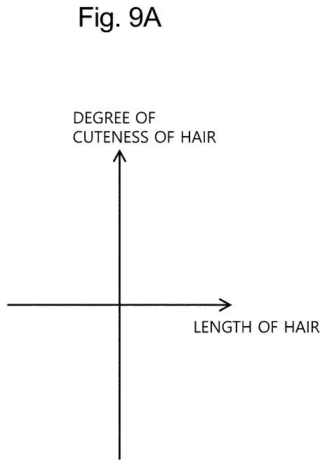

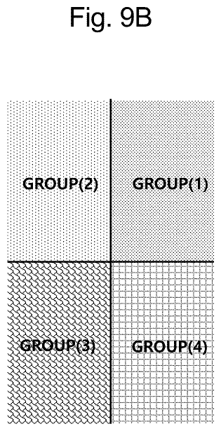

FIG. 9A and FIG. 9B are diagrams illustrating a method of arranging the plurality of items on a screen.

The plurality of items can be arranged and displayed with directionality on the screen. By this directionality, the user can easily find desired items.

Directionality refers to, for example, when the plurality of items are moved in a second direction from the area where they are arranged, at least one property, that is, a trend of the items gradually changes. The second direction may be assumed as the X-axis or the Y-axis.

The arrangement of the plurality of items may utilize at least one of the following: characteristic information of the plurality of items in a category; user preference information; statistical data; and user setting information.

The characteristic information of the plurality of items themselves in the category may include physical information such as color and the length of the item.

That is, color can classify items into achromatic and chromatic, black and white, etc. Further, length can be classified as long and short. For example, hair items can be classified on the basis of the length of hair. In detail, items can be classified in order of physical information values from smallest to largest. That is, hair items can be classified in order of hair length from shortest to longest.

The characteristic information of the plurality of items themselves in the category may include an abstract information such as adjectival expressions that are non-physical information, that is, subjective judgment information of a classifier. That is, the abstract information may be expressed adjectivally, such as cute/active, masculine/feminine/androgynous.

As for the user preference information, that is, user patterns, when initially displaying the plurality of items in the category, items that the user has worn frequently in the past, that is, items that are determined to be preferred by the user may be arranged in an area close to the character, and as the distance from the character increases, items that are determined to be less preferred by the user may be arranged. That is, as for the user preference information, items can be arranged by setting the X-axis or the Y-axis on the basis of the degree of the user's preference for the item.

It is possible to recommend items similar to the items that the user previously preferred and wore frequently in accordance with the preference of the user, using the user preference information.

As for the statistical data, it is possible to arrange items that multiple users frequently use in an area close to a character, and as the distance from the character, it is possible to arrange items that are determined to be less preferred by multiple users.

That is, items can be arranged by setting the X-axis or the Y-axis in accordance with how often other users have selected them, using statistical data. It is possible to recommend latest trending items by recommending the items that have been frequently selected by other users using statistical data that is historical data about items.

The user may directly set an arrangement criteria of each item. For example, the user may directly the arrangement criteria such as hair length and hair cuteness shown in FIG. 9A. That is, items can be arranged in accordance with direct settings by the user.

In FIG. 9A, the X-axis and the Y-axis are set around the reference position for the display area of the plurality of items and one value for items is set on each of the X-axis and the Y-axis such that arrangement of the plurality of items have directionality.

The one value is one of the elements included in the characteristic information of the plurality of items themselves in the category, the user preference information, the statistical data, and the user settings information.

For example, a hair length included in the characteristic information of the plurality of items themselves of a category is set as the X-axis and items, and shorter hair items and longer hair items can be sequentially arranged from the left side to the right side of the X-axis.

This can be equally applied to the Y-axis. For example, a hair color included in the characteristic information of the plurality of items themselves in the category may be set for the Y-axis. Alternatively, the degree of cuteness of hair may be set for the Y-axis. The Y-axis may be set such that the degree of cuteness of hair gradually increases from the lower end to the upper end of the Y-axis.

The plurality of items are set to have directionality by grouping in FIG. 9B.

The service providing apparatus 10 can group the plurality of items into multiple groups. The items belonging to the same group can be arranged in adjacent areas or in the same direction on the screen. Adjacent groups on the screen may have similar properties in comparison to non-adjacent groups. The items belonging to the same group are arranged in adjacent areas or in the same direction on the screen and groups having high similarity are arranged adjacent to each other on the screen, whereby arrangement of items have directionality.

The plurality of items may be arranged in preset multiple divided areas for each group.

For example, N areas can be divided circumferentially around a reference position. When N is 4, four groups of items can be arranged in four areas divided by the X-axis and the Y-axis around the reference position. The reference position may be set as the center position of a character or the center position of the area in which items are displayed on the screen.

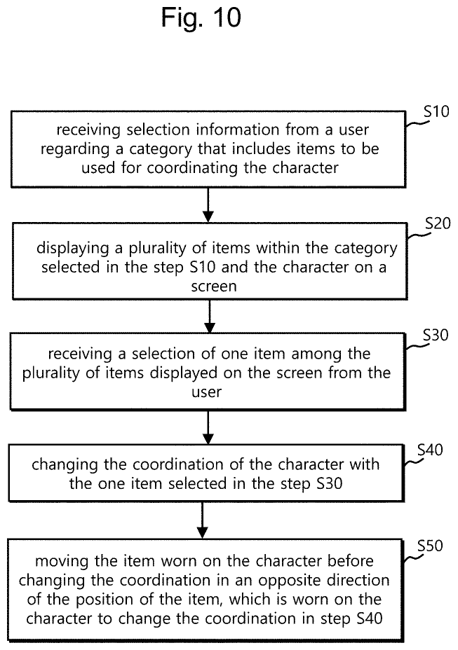

The N areas circumferentially set around the reference position, as shown in FIG. 10B, can occupy the same angle. However, when the number of items of groups to be arranged in some areas is large, the angles occupied by the N areas may be set different.

At least one of the characteristic information of the plurality of items themselves in the category, the user preference information, the statistical data, and the user settings information can be used for grouping of the plurality of items.

A method of providing character customization according to an embodiment is described hereafter. The method of providing character customization according to an embodiment is performed by the service providing apparatus 10, so the method inherently includes all the features of the service providing apparatus 10 even without separate explanation. Each step of the method of providing character customization can be performed by at least one processor P as an operation method of the service providing apparatus 10. That is, the method of providing character customization may be implemented in the form of a computer program that is executed by at least one processor P and the steps included in the method of providing character customization may be performed by one or more processors P.

The method of providing character customization may be implemented through a non-transitory computer-readable recording medium storing a program that can be executed in a computer by at least one processor P. The method of providing character customization may be implemented through a computer program stored in a recording medium.

FIG. 10 is a flowchart of a method of providing character customization according to an embodiment.

As can be seen from FIG. 10, the method of providing character customization according to an embodiment includes: receiving selection information from a user regarding a category that includes items to be used for coordinating the character (S10); displaying a plurality of items within the category selected in the step S10 and the character on a screen (S20); receiving a selection of one item among the plurality of items displayed on the screen from the user (S30); changing the coordination of the character with the one item selected in the step S30 (S40); and moving the item worn on the character before changing the coordination in an opposite direction of the position of the item, which is worn on the character to change the coordination in step S40, before being worn on the character (S50).

The plurality of items are each represented in different sizes, depending on the distance from the character.

The selection of the one item among the plurality of items by the user may be performed by one of the following: pressing the one item; or contact between the one item and the character's area caused by a movement of the one item among the plurality of items.

Additionally, the movement of the one item among the plurality of items in the S30 may be performed by moving the display area itself of the plurality of items on the screen.

At least one category among categories including items used for coordinating the character comprises a removal item that can remove an item from the same category currently worn on the character. Accordingly, in the step S40, when the selected item is the removal item that can remove another item, the character enters a state where no item is worn in the corresponding category.

In the step S20, the plurality of items may be arranged with directionality on the screen. In detail, the arrangement of the plurality of items may utilize at least one of the following: characteristic information of the plurality of items in a category; user preference information; statistical data; and user setting information.

For example, in the step S20, the X-axis and the Y-axis are set around a reference position for the display area of the plurality of items and one value for items is set on each of the X-axis and the Y-axis, whereby arrangement of the plurality of items can have directionality.

Alternatively in the step S20, the plurality of items may be grouped into multiple groups and arranged in preset multiple divided areas for each group. In this case, the items belonging to the same group can be arranged in adjacent areas or in the same direction on the screen. Adjacent groups on the screen may have similar properties in comparison to non-adjacent groups. The items belonging to the same group are arranged in adjacent areas or in the same direction on the screen and groups having high similarity are arranged adjacent to each other on the screen, whereby arrangement of items have directionality.

The method of providing character customization according to an embodiment may further include changing the icon representing the current category item into an activated state by moving the background screen through touch and drag with the icon representing another category item activated.

In the step S50, a second item is moved to a position that is symmetrically opposite to a first location relative to the character's position on the screen. The first location refers to the position of a first item before it is worn on the character. The first item is an item worn on the character after the change in the character's coordination, and the second item is an item worn on the character before the change in the character's coordination.

As described above, according to the service providing apparatus 10 providing character customization and an operation method of the service providing apparatus 10, it can be seen that it is possible not only to propose various coordination items in a use-friendly way, but to more conveniently change items.

What is claimed is:

1. A method of providing character customization, the method comprising:
(a) receiving selection information from a user regarding a category that includes items to be used for coordinating the character;
(b) displaying a plurality of items within the category selected in the step (a) and the character on a screen;
(c) receiving a selection of one item among the plurality of items displayed on the screen from the user; and
(d) changing the coordination of the character with the one item selected in the step (c).

2. The method of claim 1, wherein the selection of the one item among the plurality of items by the user in the step (c) may be performed by one of the following:
pressing the one item; or
contact between the one item and an area of the character caused by a movement of the one item among the plurality of items.

3. The method of claim 2, wherein the movement of the one item among the plurality of items is performed by moving a display area itself of the plurality of items on the screen.

4. The method of claim 1, wherein, in the step (b), the plurality of items are each displayed in different sizes, depending on a distance from the character.

5. The method of claim 1, wherein at least one category among categories including items used for coordinating the character comprises a removal item that can remove an item from the same category currently worn on the character.

6. The method of claim 1, wherein, in the step (b), the plurality of items are arranged with directionality on the screen.

7. The method of claim 1, further comprising:
(e) moving a second item to a position that is opposite to a first location relative to the character's position on the screen,
wherein the first location is the position of a first item before the first item is worn on the character,
the first item is an item worn on the character after the change in the character's coordination,
and the second item is an item worn on the character before the change in the character's coordination.

8. A non-transitory computer-readable recording medium storing a program to perform the method of claim 1.

9. A service providing apparatus providing character customization, wherein the service providing apparatus receives selection information of a category including items to be used for coordination of the character from a user, displays the character and a plurality of items of the selected category on a screen, receives a selection of one item among the plurality of items displayed on the screen from the user, and changes the coordination of the character with selected the one item.

10. The service providing apparatus of claim 9, wherein the selection of the one item among the plurality of items by the user can be performed by one of the following:
pressing the one item; or
contact between the one item and an area of the character caused by a movement of the one item among the plurality of items.

11. The service providing apparatus of claim 10, wherein movement of the one item among the plurality of items is performed by moving a display area itself of the plurality of items on the screen.

12. The service providing apparatus of claim 9, wherein the plurality of items are each displayed in different sizes, depending on a distance from the character.

13. The service providing apparatus of claim 9, wherein at least one category among categories including items used for coordinating the character comprises a removal item that can remove an item from the same category currently worn on the character.

14. The service providing apparatus of claim 9, wherein the plurality of items are arranged with directionality on the screen.

15. The service providing apparatus of claim 9, wherein the service providing apparatus moves a second item to a position that is opposite to a first location relative to the character's position on the screen,
wherein the first location is the position of a first item before the first item is worn on the character,
the first item is an item worn on the character after the change in the character's coordination,
and the second item is an item worn on the character before the change in the character's coordination.
